(19) United States
(12) Patent Application Publication
(10) Pub. No.: US 2020/0264747 A1
(43) Pub. Date: Aug. 20, 2020

(54) IMAGE SHARING METHOD AND IMAGE SHARING SYSTEM

(71) Applicant: LENOVO (SINGAPORE) PTE. LTD., Singapore (SG)

(72) Inventor: Yasushi Tsukamoto, YOKOHAMA (JP)

(73) Assignee: LENOVO (SINGAPORE) PTE. LTD., SINGAPORE (SG)

(21) Appl. No.: 16/503,541

(22) Filed: Jul. 4, 2019

(30) Foreign Application Priority Data
Feb. 18, 2019 (JP) 2019026734

(51) Int. Cl. G06F 3/0484; G06F 17/22

(52) U.S. Cl. CPC G06F 3/0484; G06F 17/2247

(57) ABSTRACT

An information sharing method includes a first analysis step of analyzing a structure of a Web page being displayed, and associating a Web part with part identification information included in the Web part; a positional relationship generating step of generating a relative positional relationship between the Web part and a first display position on a display screen of the first terminal device; a second analysis step of analyzing a structure of the Web page when displayed in the own device, and associating the Web part with the part identification information; and a display step of determining a second display position for displaying the Web page on a display screen of the second terminal device on the basis of the relative positional relationship and the second analysis result obtained, and displaying the Web page on the display screen of the second terminal device in the second display position.

### FIELD OF THE INVENTION

The present invention relates to an information sharing method and an information sharing system.

### BACKGROUND OF THE INVENTION

In recent years, Web pages are displayed in different designs depending on the types of terminal devices such as smartphone, personal computer (PC), etc.

[Patent Document 1] Japanese Unexamined Patent Application Publication No. 2018-128746.

### SUMMARY OF THE INVENTION

However, for example when a smartphone and a PC are used to display a same Web page on the two terminal devices, the Web page will be displayed in different designs on the different terminal devices, occasionally making it difficult to display a same position in the Web page on the devices. That is to say, with the conventional technique described above, it might be difficult to make different terminal devices display the same information, hindering appropriate sharing of information.

The present invention has been made to solve the above problem, with an object to provide an information sharing method and an information sharing system allowing information to be shared appropriately between different terminal devices.

To solve the above problem, a first aspect of the present invention provides an information sharing method for sharing information between a first terminal device and a second terminal device, the method including: a first analysis step, performed by the first terminal device, of analyzing a structure of a Web page being displayed, and associating a Web part included in the Web page with part identification information included in the Web part and capable of identifying the Web part; a positional relationship generating step, performed by the first terminal device on the basis of a first analysis result as an analysis result obtained in the first analysis step, of generating a relative positional relationship between the Web part including the part identification information and a first display position on a display screen of the first terminal device in a state where the Web page is being displayed thereon; a second analysis step, performed by the second terminal device, of analyzing a structure of the Web page in a case of being displayed in the second terminal device, and associating the Web part included in the Web page with the part identification information; and a display step, performed by the second terminal device, of determining a second display position for displaying the Web page on a display screen of the second terminal device on the basis of the relative positional relationship generated in the positional relationship generating step and a second analysis result as an analysis result obtained in the second analysis step, and displaying the Web page on the display screen of the second terminal device at the second display position.

In the information sharing method according to the first aspect of the present invention, in the display step, the second terminal device may select at least two said Web parts closest in distance to the first display position in the display of the first terminal device on the basis of the relative positional relationships and the second analysis result, determine the second display position as a scroll position of the Web page on the basis of the relative positional relationships between the selected at least two Web parts and the first display position, and display the Web page on the display screen of the second terminal device by shifting the Web page to the scroll position.

In the information sharing method according to the first aspect of the present invention, the relative positional relationships between the two Web parts and the first display position may be a ratio between distances of start positions of the Web parts from the first display position.

In the information sharing method according to the first aspect of the present invention, in the display step, in a case where one or both of the selected at least two Web parts do not exist in the display of the second terminal device, the second terminal device may select one or two said Web parts next closest in distance to the first display position.

In the information sharing method according to the first aspect of the present invention, in the display step, the second terminal device may exclude any said Web part that is displayed in the display of the second terminal device in reverse order as compared to that in the display of the first terminal device, from candidates for the at least two Web parts selected.

In the information sharing method according to the first aspect of the present invention, the part identification information may include an ID name of the Web part, text information included in the Web part, or a file name included in the Web part.

Further, the information sharing method according to the first aspect of the present invention may include: a setup information outputting step, performed by the first terminal device, of outputting cookie information accumulated when browsing the Web page to the outside; and a setup information acquiring step, performed by the second terminal device, of acquiring the cookie information output in the setup information outputting step, wherein in the display step, the second terminal device may display the Web page by sharing the cookie information acquired in the setup information acquiring step with the first terminal device.

Further, the information sharing method according to the first aspect of the present invention may include: an environmental information outputting step, performed by the first terminal device, of outputting user agent information as environmental information of the first terminal device when browsing the Web page to the outside; and an environmental information acquiring step, performed by the second terminal device, of acquiring the user agent information output in the environmental information outputting step, wherein in the display step, the second terminal device may acquire the Web page by transmitting the user agent information acquired in the environmental information acquiring step to a Web server.

A second aspect of the present invention provides an information sharing system including a first terminal device and a second terminal device and sharing information between the first terminal device and the second terminal device, wherein the first terminal device includes: a first analysis unit configured to analyze a structure of a Web page being displayed by the first terminal device, and associate a Web part included in the Web page with part identification information included in the Web part and capable of identifying the Web part; and a positional relationship generating unit configured to generate, on the basis of a first analysis result as an analysis result obtained by the first analysis unit, a relative positional relationship between the Web part including the part identification information and a first display position on a display screen of the first terminal device in a state where the Web page is being displayed thereon, and the second terminal device includes: a second analysis unit configured to analyze a structure of the Web page in a case of being displayed in the second terminal device, and associate the Web part included in the Web page with the part identification information; and a display processing unit configured to determine a second display position for displaying the Web page on a display screen of the second terminal device on the basis of the relative positional relationship generated by the positional relationship generating unit and a second analysis result as an analysis result obtained by the second analysis unit, and display the Web page on the display screen of the second terminal device in the second display position.

The above-described aspects of the present invention enable appropriate sharing of information between different terminal devices.

### BRIEF DESCRIPTION OF THE DRAWINGS

FIG. 1 is a block diagram showing an example of an information sharing system according to a first embodiment;

FIG. 2 shows an exemplary way of switching between Web page display designs according to terminal devices;

FIG. 3 shows an exemplary description of the ID name of a Web part;

FIG. 4 shows, by way of example, a Web page analysis result and positional relationships in the first embodiment;

FIG. 5 shows an exemplary way of determining a scroll position in a receiving terminal device in the first embodiment;

FIG. 6 shows another exemplary way of determining the scroll position in the receiving terminal device in the first embodiment;

FIG. 7 shows, by way of example, an operation of the information sharing system according to the first embodiment;

FIG. 8 is a flowchart illustrating, by way of example, processing of determining the scroll position in the receiving terminal device according to the first embodiment;

FIG. 9 is a block diagram showing an example of an information sharing system according to a second embodiment;

FIG. 10 shows, by way of example, an operation of the information sharing system according to the second embodiment; and

FIG. 11 is a block diagram showing an example of an information sharing system according to a third embodiment.

### DETAILED DESCRIPTION OF THE INVENTION

The information sharing method and the information sharing system according to embodiments of the present invention will be described below with reference to the drawings.

### First Embodiment

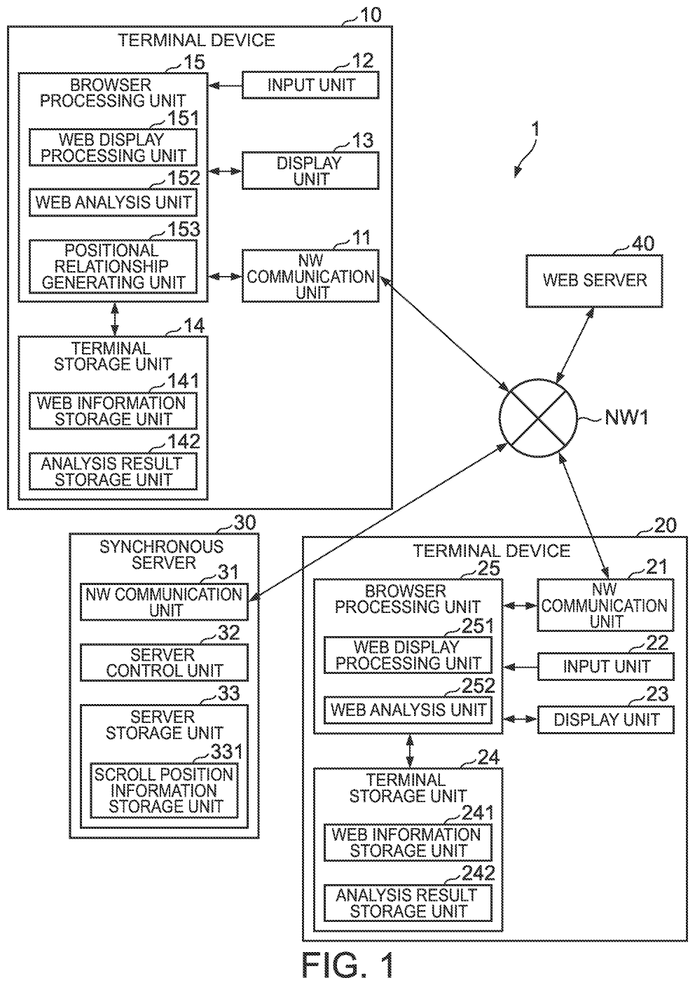

FIG. 1 is a block diagram showing an example of an information sharing system 1 according to the present embodiment.

As shown in FIG. 1, the information sharing system 1 includes a terminal device 10, a terminal device 20, a synchronous server 30, and a Web server 40. The information sharing system 1 shares information (for example, display position of Web display) between the terminal device 10 and the terminal device 20.

The terminal device 10, the terminal device 20, the synchronous server 30, and the Web server 40 are connectable via a network NW1 and capable of communicating information with each other via the network NW1.

The Web server 40 is a server device that acquires HyperText Markup Language (HTML) data as Web page data when the terminal device 10 and the terminal device 20 are to display the Web page.

The terminal device 10 is an information terminal such as a smartphone, for example, and displays a Web page acquired from the Web server 40 by using a browser function of browsing Web pages.

It should be noted that in the present embodiment, a description will be given of a case where the terminal device 10 is a smartphone, which is a first terminal device as a sending terminal device, and the terminal device 20, which will be described later, is a personal computer (PC), which is a second terminal device as a receiving terminal device.

The terminal device 10 includes a network (NW) communication unit 11, an input unit 12, a display unit 13, a terminal storage unit 14, and a browser processing unit 15.

The NW communication unit 11 connects to the network NW1 using a wireless local area network (LAN) communication, a mobile communication of mobile phone or the like, and performs various communications via the network NW1. For example, the NW communication unit 11 connects to the synchronous server 30 and the Web server 40 via the network NW1, and performs various communications between the terminal device 10 on the one hand and the synchronous server 30 or the Web server 40 on the other hand.

The input unit 12 is an input device such as a keyboard, a touch panel, and/or a mouse, for example, and accepts user input information including input of information and choice from options by the user. The input unit 12 outputs the accepted user input information to the browser processing unit 15.

The display unit 13 is a liquid crystal display device, for example, and displays various kinds of information. For example, the display unit 13 displays a Web page under the control of the browser processing unit 15.

The terminal storage unit 14 stores various kinds of information used by the terminal device 10. For example, the terminal storage unit 14 includes a Web information storage unit 141 and an analysis result storage unit 142.

The Web information storage unit 141 stores Web page data (for example, HTML data) acquired from the Web server 40.

The analysis result storage unit 142 stores a Web page analysis result as a result of analysis by a Web analysis unit 152 (described later). The analysis result will be described in detail later.

It should be noted that Web data is configured in different designs, depending on the types (for example, smartphone, PC, etc.) of the terminal device 10, by the Web page design information called cascading style sheets (CSS). The Web page design is switched depending on the type of the terminal device 10, and Web data of a distinct design is acquired from the Web server 40.

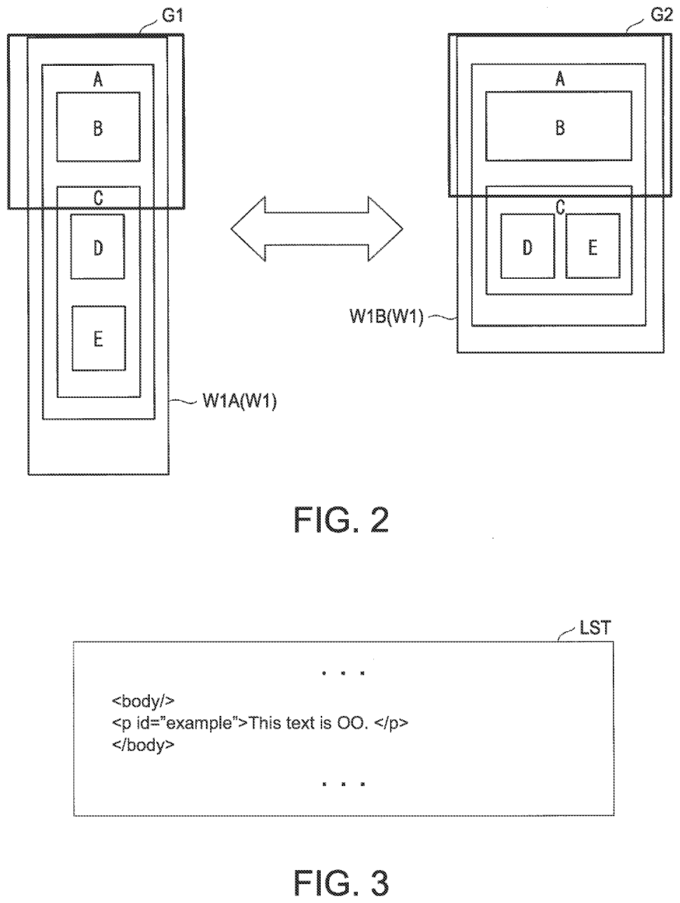

FIG. 2 shows an exemplary way of switching to a Web page display design according to a terminal device 10 (20).

Referring to FIG. 2, a Web page W1A shows a page configuration in the case where a Web page W1 provided by the Web server 40 is displayed on the terminal device 10 (smartphone), and a display screen G1 shows a display screen to be displayed on the display unit 13 of the terminal device 10. A Web page W1B shows a page configuration in the case where the Web page W1 provided by the Web server 40 is displayed on the terminal device 20 (PC), and a display screen G2 shows a display screen to be displayed on the display unit 23 of the terminal device 20.

In the example shown in FIG. 2, the display unit 13 of the terminal device 10 and the display unit 23 of the terminal device 20 have their display screens different in size and shape, and the Web page W1A and the Web page W1B are switched and displayed on the corresponding display screens (G1, G2).

Returning to the description of FIG. 1, the browser processing unit 15 is a functional unit that is implemented as a browser program is executed by a central processing unit (CPU) and a memory (both not shown). The browser processing unit 15 acquires data on a Web page from the Web server 40, and displays the Web page on the display unit 13. The browser processing unit 15 includes a Web display processing unit 151, a Web analysis unit 152, and a positional relationship generating unit 153.

The Web display processing unit 151 acquires data on a Web page from the Web server 40 and displays the acquired Web page on the display unit 13. The Web display processing unit 151 stores the acquired data on the Web page in the Web information storage unit 141. Further, the Web display processing unit 151 performs processing of changing the Web page displayed, or changing the display position (for example, scroll position) of the Web page, for example, on the basis of the input information acquired from the user via the input unit 12.

The Web analysis unit 152 (an example of first analysis unit) analyzes the structure of the Web page being displayed, and associates a Web part included in the Web page with an ID name (an example of part identification information) that is included in the Web part and capable of identifying the Web part. As used herein, the Web parts are parts of hierarchical structure constituting the Web page W1A in FIG. 2, for example, which are Web parts A to E. The ID names are specific identification names assigned to the elements using id attributes, such as an HTML description LST shown in FIG. 3.

The Web analysis unit 152 analyzes HTML data on a Web page stored in the Web information storage unit 141, for example, and lists the Web parts having ID names to generate an analysis result of the hierarchical structure as in the Web page W1A in FIG. 2. The Web analysis unit 152 stores the analysis result in the analysis result storage unit 142.

It should be noted that in the present embodiment, the analysis result of the Web page W1A displayed by the sending terminal device 10 may be referred to as a first analysis result.

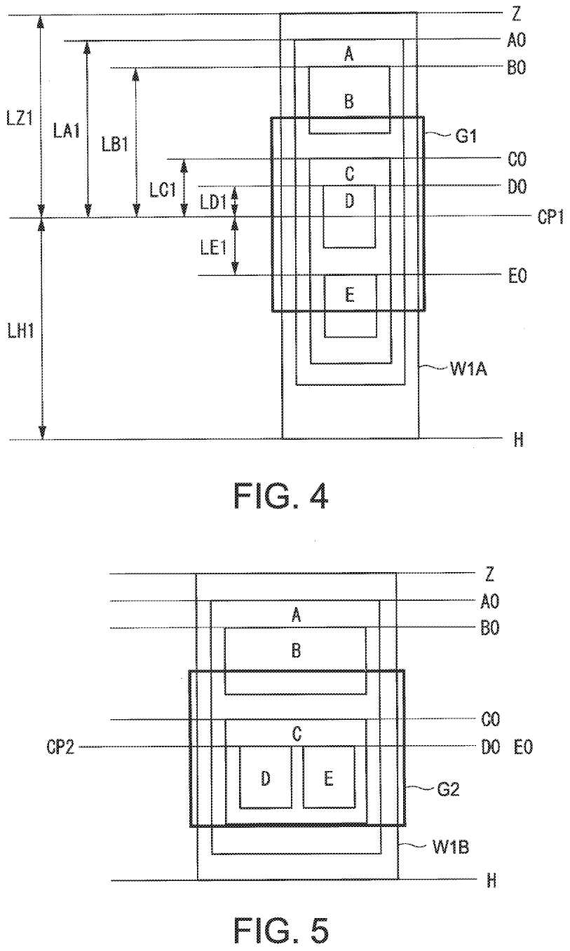

The positional relationship generating unit 153 is operative, on the basis of the first analysis result, which is the analysis result obtained by the Web analysis unit 152, to generate a relative positional relationship between a Web part including an ID name and a central position (first display position) on the display screen G1 of the terminal device 10 in the state where the Web page is being displayed thereon. For example, the positional relationship generating unit 153 acquires the analysis result stored in the analysis result storage unit 142, and calculates a distance from the scroll position (central position on the display screen G1 of the display unit 13) to a start position of a respective Web part having an ID name. On the basis of each distance calculated, the positional relationship generating unit 153 generates a relative positional relationship between each Web part and the scroll position, as shown in FIG. 4, as scroll position information (normalized distance information).

FIG. 4 shows, by way of example, an analysis result of the Web page W1A and positional relationships therein in the present embodiment.

Referring to FIG. 4, the central position CP1 of the display screen G1 indicates the scroll position of the Web page W1A. Positions A0 to E0 indicate positions where the respective Web parts A to E start. Distances LA1 to LE1 indicate distances of the start positions (positions A0 to E0) of the respective Web parts with respect to the central position CP1. A position Z indicates a top position where the Web page W1A starts, and a distance LZ1 indicates a distance of the top position Z of the Web page W1A with respect to the central position CP1. A position H indicates a bottom position where the Web page W1A ends, and a distance LH1 indicates a distance of the bottom position H of the Web page W1A with respect to the central position CP1.

The positional relationship generating unit 153 generates the relative positional relationships with relative to the central position CP1 (scroll position) as shown in FIG. 4. Further, the positional relationship generating unit 153 transmits the generated relative positional relationships, as scroll position information, together with Web information that identifies the Web page (for example, uniform resource locator (URL) information of the Web page W1A), to the synchronous server 30 via the NW communication unit 11.

Returning again to the description of FIG. 1, the synchronous server 30 is a server device for sharing information (for example, scroll position of the Web page W1) between the sending terminal device 10 and the receiving terminal device 20. The synchronous server 30 includes a NW communication unit 31, a server control unit 32, and a server storage unit 33.

The NW communication unit 31 connects to the network NW1 using a wired LAN communication, for example, and performs various communications via the network NW1. For example, the NW communication unit 31 performs various communications with the terminal device 10 and the terminal device 20 via the network NW1.

The server control unit 32 is a processor including a CPU and others, for example, and performs overall control of the synchronous server 30. For example, the server control unit 32 stores scroll position information and Web information, acquired from the terminal device 10 via the NW communication unit 31, in association with each other in the server storage unit 33. Further, for example, the server control unit 32 acquires the scroll position information and the Web information stored in the server storage unit 33, and transmits the acquired information to the terminal device 20 via the NW communication unit 31.

The server storage unit 33 stores various kinds of information used by the synchronous server 30. The server storage unit 33 includes a scroll position information storage unit 331, for example.

The scroll position information storage unit 331 stores the above-described scroll position information (relative positional relationships). For example, the scroll position information storage unit 331 stores a user ID (user identification information) of the synchronous server 30, Web information (URL information etc.), and the scroll position information, in association with each other.

The terminal device 20 (an example of second terminal device) is an information terminal such as a PC, for example, and displays a Web page acquired from the Web server 40 using a browser function of browsing Web pages. The terminal device 20 includes a NW communication unit 21, an input unit 22, a display unit 23, a terminal storage unit 24, and a browser processing unit 25.

The NW communication unit 21 connects to the network NW1 using a wireless LAN communication, a mobile communication of mobile phone or the like, and performs various communications via the network NW1. For example, the NW communication unit 21 connects to the synchronous server 30 and the Web server 40 via the network NW1, and performs various communications between the terminal device 20 on the one hand and the synchronous server 30 or the Web server 40 on the other hand.

The input unit 22 is an input device such as a keyboard, a touch panel, and/or a mouse, for example, and accepts user input information including input of information and choice from options by the user. The input unit 22 outputs the accepted user input information to the browser processing unit 25.

The display unit 23 is a liquid crystal display device, for example, and displays various kinds of information. For example, the display unit 23 displays a Web page under the control of the browser processing unit 25.

The terminal storage unit 24 stores various kinds of information used by the terminal device 20. For example, the terminal storage unit 24 includes a Web information storage unit 241 and an analysis result storage unit 242.

The Web information storage unit 241 stores Web page data (for example, HTML data) acquired from the Web server 40.

The analysis result storage unit 242 stores a Web page analysis result (second analysis result) as a result of analysis by a Web analysis unit 252 (described later). This analysis result is similar to the analysis result of the Web analysis unit 152 described above. For example, the analysis result of the hierarchical structure as in the Web page W1B in FIG. 2 is stored.

The browser processing unit 25 is a functional unit that is implemented as a browser program is executed by a CPU and a memory (both not shown). The browser processing unit 25 acquires data on a Web page from the Web server 40, and displays the Web page on the display unit 23. The browser processing unit 25 includes a Web display processing unit 251 and a Web analysis unit 252.

The Web analysis unit 252 (an example of second analysis unit) analyzes a structure of the Web page in the case of being displayed on the terminal device 20, and associates a Web part included in the Web page with an ID name that is included in the Web part and capable of identifying the Web part. Here, the Web parts are parts of the hierarchical structure constituting the Web page W1B in FIG. 2, for example, which are Web parts A to E.

The Web display processing unit 251 acquires data on a Web page from the Web server 40 and displays the acquired Web page on the display unit 23. The Web display processing unit 251 stores the acquired data on the Web page in the Web information storage unit 241.

Further, the Web display processing unit 251 determines a scroll position (second display position) for displaying the Web page W1B on the display screen G2 of the terminal device 20, on the basis of the above-described relative positional relationships (scroll position information) generated by the positional relationship generating unit 153 and the second analysis result which is the result of analysis made by the Web analysis unit 252. The Web display processing unit 251 then displays the Web page W1B on the display screen G2 of the terminal device 20 at the determined scroll position.

For example, on the basis of the above-described scroll position information (relative positional relationships) and the second analysis result, the Web display processing unit 251 selects at least two Web parts that are closest in distance to the central position CP1 (first display position) on the display screen G1 in the display of the terminal device 10. Then, on the basis of the relative positional relationships between the at least two Web parts selected and the central position CP1, the Web display processing unit 251 determines a scroll position as the scroll position of the Web page W1B, and displays the Web page W1B on the display screen G2 of the terminal device 20 by shifting the page to that scroll position.

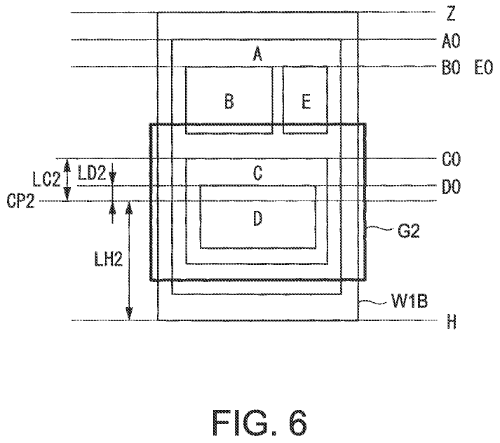

Specific examples of determining the scroll position (second display position) by the Web display processing unit 251 will be described below with reference to FIGS. 5 and 6.

FIG. 5 shows an exemplary way of determining the scroll position in the receiving terminal device 20 in the present embodiment.

Referring to FIG. 5, the configuration of the Web page W1B is the analysis result obtained by the Web analysis unit 252. Positions A0 to E0 are positions where the respective Web parts A to E start.

The Web display processing unit 251 selects two Web parts (D, E) closest to the central position CP1 of the display screen G1 of the terminal device 10, from the scroll position information (relative positional relationships) shown in FIG. 4. Further, the Web display processing unit 251 determines the display position (scroll position) of the Web page W1B so as to be consistent with the ratio (LD1:LE1) between the distances of the Web parts (D, E) from the central position CP1. In FIG. 5, the Web parts D and E are arranged at the same scroll position. The Web display processing unit 251 therefore determines, as the corresponding scroll position, the position where a central position CP2 of the display screen G2 and the start positions D0 and E0 of the Web parts D and E coincide with each other.

As a result, in the example shown in FIG. 5, the Web display processing unit 251 displays the Web page W1B at the scroll position where the start position D0 of the Web part D and the start position E0 of the Web part E coincide with the central position CP2 of the display screen G2.

As described above, the relative positional relationships between the two Web parts (D, E) and the central position CP1 of the display screen G1 correspond to the ratio (LD1:LE1) between the distances of the start positions (D0, E0) of the Web parts (D, E) from the central position CP1. The Web display processing unit 251 determines the scroll position of the Web page W1B on the basis of this distance ratio (LD1:LE1).

FIG. 6 shows another exemplary way of determining the scroll position in the receiving terminal device 20 in the present embodiment.

Referring to FIG. 6, the configuration of the Web page W1B is the analysis result obtained by the Web analysis unit 252. Positions A0 to E0 indicate positions where the respective Web parts A to E start. In the example shown in FIG. 6, the display order of the Web part D and the Web part E is reversed as compared to that in the Web page W1A displayed by the sending terminal device 10.

In this case, although the Web display processing unit 251 selects two Web parts (D, E) from the scroll position information (relative positional relationships) shown in FIG. 4, the analysis result of the Web page W1B indicates that they are displayed in reverse order as compared to that in the display of the terminal device 10, so the Web display processing unit 251 excludes the Web part E, and selects the next closest Web part C. The Web display processing unit 251 then determines the display position (scroll position) of the Web page W1B so as to be consistent with the ratio (LC1:LD1) between the distances of the Web parts (C, D) from the central position CP1.

Specifically, referring to FIG. 6, the Web display processing unit 251 determines the scroll position in such a manner that a ratio (LC2:LD2) between a distance LC2 of the start position C0 of the Web part C from the central position CP2 of the display screen G2 and a distance LD2 of the start position D0 of the Web part D from the central position CP2 of the display screen G2 agrees with the distance ratio (LC1:LD1).

As a result, in the example shown in FIG. 6, the Web display processing unit 251 displays the Web page W1B at the scroll position in such a manner that the determined scroll position coincides with the central position CP2 of the display screen G2.

As described above, the Web display processing unit 251 excludes any Web part (for example, Web part E) that is displayed in the terminal device 20 in reverse order as compared to that in the terminal device 10, from the candidates for at least two Web parts selected.

Although not shown in the figure, if one or both of the at least two Web parts selected do not exist in the display of the terminal device 20 (the display of the Web page W1B), the Web display processing unit 251 selects the Web part(s) next closest in distance to the first display position.

Further, the Web display processing unit 251 may use a top position Z or a bottom position H of the Web page W1B in place of the start position of a Web part. For example, referring to FIG. 6, the Web display processing unit 251 may determine the scroll position in accordance with the ratio between the distance LC2 of the Web part C and a distance LH2 of the bottom position.

The operation of the information sharing system 1 according to the present embodiment will be described below with reference to the drawings.

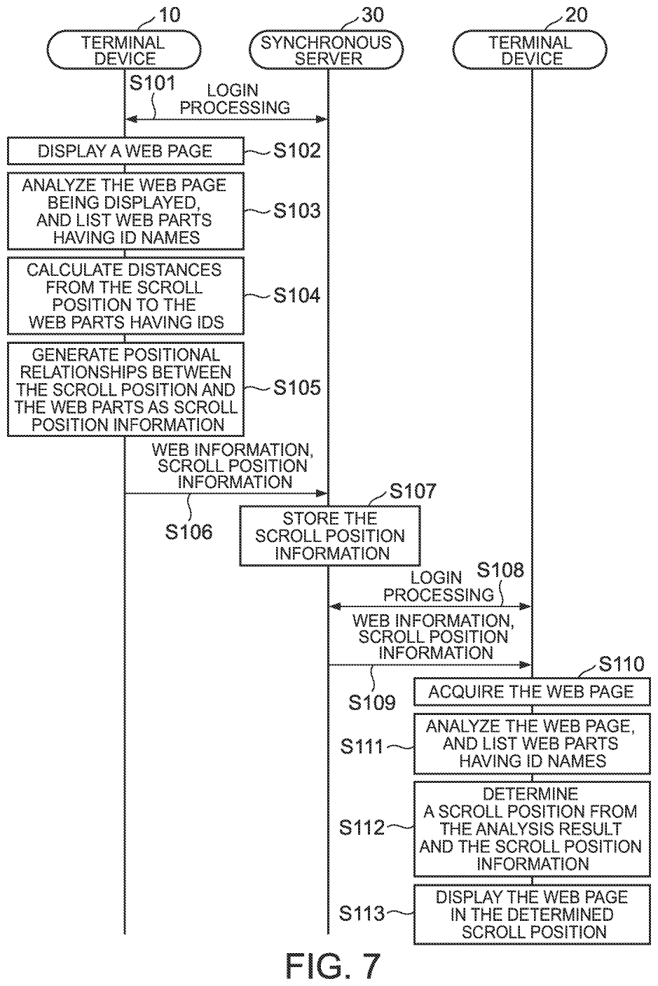

FIG. 7 shows, by way of example, the operation of the information sharing system 1 according to the present embodiment.

Here, a description will be given of an example where the Web page being displayed by the sending terminal device 10 is to be displayed on the receiving terminal device 20 with the scroll position shared (synchronized) therebetween.

Referring to FIG. 7, firstly, when a user starts a browser program, the terminal device 10 performs login processing on the synchronous server 30 (step S101). The browser processing unit 15 of the terminal device 10 transmits a pre-registered user ID and login password to the synchronous server 30 via the NW communication unit 11, to log in to the synchronous server 30.

Next, the terminal device 10 displays a Web page (step S102). The Web display processing unit 151 of the browser processing unit 15 acquires, via the NW communication unit 11, data on the Web page from the Web server 40 corresponding to the URL information designated in accordance with the user manipulation via the input unit 12, and displays the Web page on the display unit 13. Further, the Web display processing unit 151 stores the acquired data on the Web page in the Web information storage unit 141 of the terminal storage unit 14.

Next, the Web analysis unit 152 of the browser processing unit 15 analyzes the Web page being displayed, and lists Web parts having ID names (step S103). The Web analysis unit 152 analyzes the hierarchical structure as shown in the Web page W1A in FIG. 2, for example, on the basis of the data on the Web page stored in the Web information storage unit 141. The Web analysis unit 152 stores the analysis result in the analysis result storage unit 142 of the terminal storage unit 14.

Next, the positional relationship generating unit 153 of the browser processing unit 15 calculates a distance from the scroll position to a Web part having an ID (step S104). For example, the positional relationship generating unit 153 calculates the distances (LA1-LE1, LZ1, and LH1) as shown in FIG. 4 on the basis of the analysis result of the Web analysis unit 152 stored in the analysis result storage unit 142.

Next, the positional relationship generating unit 153 generates positional relationships between the scroll position (central position CP1) and the Web parts, as scroll position information (step S105). For example, the positional relationship generating unit 153 calculates the relative positional relationships (scroll position information) as shown in FIG. 4.

Next, the terminal device 10 transmits the Web information and the scroll position information to the synchronous server 30 (step S106). The positional relationship generating unit 153 transmits the generated scroll position information and the Web information (for example, URL information of the Web page) to the synchronous server 30 via the NW communication unit 11.

Next, the synchronous server 30 stores the scroll position information (step S107). The server control unit 32 of the synchronous server 30 receives the scroll position information and the Web information (for example, URL information of the Web page) via the NW communication unit 31. For example, the server control unit 32 stores the received scroll position information, the Web information (for example, URL information of the Web page), and the user ID, in association with each other, in the scroll position information storage unit 331 of the server storage unit 33.

Next, the terminal device 20, in response to a user starting a browser program, performs login processing on the synchronous server 30 (step S108). The browser processing unit 25 of the terminal device 20 transmits a pre-registered user ID and login password to the synchronous server 30 via the NW communication unit 21, to log in to the synchronous server 30.

Here, it is assumed that the user of the terminal device 10 and the user of the terminal device 20 are the same, or, the same user ID is used for logging in to the synchronous server 30.

Next, the synchronous server 30 transmits the Web information and the scroll position information to the terminal device 20 (step S109). The server control unit 32 acquires the Web information (URL information) and the scroll position information corresponding to the logged-in user ID from the scroll position information storage unit 331, and transmits those Web information (URL information) and scroll position information to the terminal device 20 via the NW communication unit 31.

Next, the terminal device 20 acquires the Web page (step S110). The Web display processing unit 251 of the browser processing unit 25 acquires data on the Web page corresponding to the Web information (URL information) acquired from the synchronous server 30 via the NW communication unit 21. The Web display processing unit 251 stores the acquired data on the Web page in the Web information storage unit 241 of the terminal storage unit 24.

Next, the Web analysis unit 252 of the browser processing unit 25 analyzes the Web page, and lists Web parts having ID names (step S111). On the basis of the data on the Web page stored in the Web information storage unit 241, the Web analysis unit 252 analyzes the hierarchical structure as shown in the Web page W1B in FIG. 2, for example. The Web analysis unit 252 stores the analysis result in the analysis result storage unit 242 of the terminal storage unit 24.

Next, the Web display processing unit 251 determines a scroll position from the analysis result and the scroll position information (step S112). The Web display processing unit 251, on the basis of the analysis result of the Web analysis unit 252 stored in the analysis result storage unit 242 and the scroll position information received from the synchronous server 30, determines the scroll position in the display screen G2 of the display unit 23. For example, the Web display processing unit 251 selects two Web parts closest in distance to the central position CP1 of the display screen G1 in the display of the terminal device 10, and determines the scroll position in the display screen G2 of the display unit 23 in such a manner that the ratio between the distances of the start positions of the Web parts from the first display position is kept consistent in the display of the terminal device 20.

Next, the Web display processing unit 251 displays the Web page at the determined scroll position (step S113). The Web display processing unit 251 displays the Web page acquired from the Web server 40 on the display unit 23 in such a manner that the determined scroll position coincides with the central position CP2 of the display screen G2.

In the above-described example shown in FIG. 7, when there is a change in scroll position information, the synchronous server 30 transmits the scroll position information to the terminal device 20. The configuration however is not limited thereto. When there is a change in scroll position information, the synchronous server 30 may use a notification function of progressive web apps (PWA), for example, to send a message indicating the occurrence of the change in the scroll position information to the terminal device 20, to cause the terminal device 20 to acquire the scroll position information from the synchronous server 30.

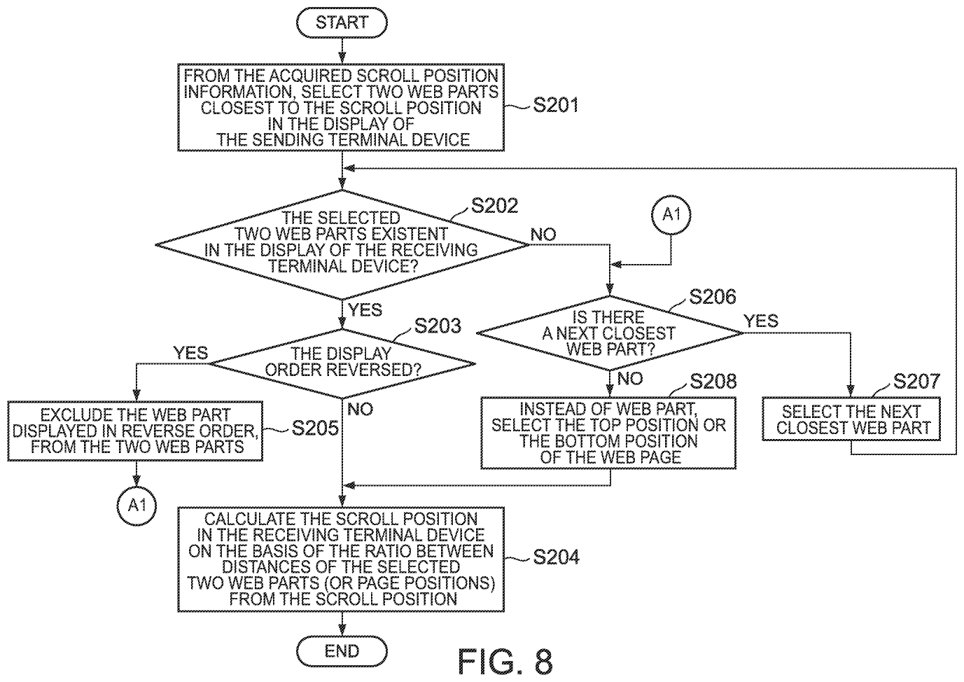

The processing in the above-described step S112 in FIG. 7 will now be described in detail with reference to FIG. 8.

FIG. 8 is a flowchart illustrating an example of the processing of determining the scroll position in the receiving terminal device 20 according to the present embodiment.

As shown in FIG. 8, firstly, the Web display processing unit 251 of the terminal device 20 selects, from the acquired scroll position information, two Web parts closest to the scroll position in the display of the sending terminal device 10 (step S201). The Web display processing unit 251 selects two Web parts, for example the Web parts D and E shown in FIG. 4, closest to the central position CP1, as the scroll position, of the display screen G1.

Next, the Web display processing unit 251 determines whether the selected two Web parts are present in the display of the receiving terminal device 20 (step S202). The Web display processing unit 251 determines whether the ID names of the selected Web parts D and E are included in the analysis result stored in the analysis result storage unit 242. If the selected two Web parts are present (YES in step S202), the Web display processing unit 251 advances the process to step S203. If either one of the selected two Web parts is not present (NO in step S202), the Web display processing unit 251 advances the process to step S206.

In step S203, the Web display processing unit 251 determines whether the two Web parts are displayed in reverse order. The Web display processing unit 251 determines whether the selected two Web parts are displayed in reverse order as compared to that in the sending terminal device 10, on the basis of the analysis result stored in the analysis result storage unit 242. If the display order is reversed (YES in step S203), the Web display processing unit 251 advances the process to step S205. If the display order is not reversed (NO in step S203), the Web display processing unit 251 advances the process to step S204.

In step S204, the Web display processing unit 251 calculates the scroll position in the receiving terminal device 20 on the basis of the ratio between the distances of the selected two Web parts (or page positions) from the scroll position. For example, the Web display processing unit 251 calculates the scroll position as described above in conjunction with FIGS. 5 and 6. After the processing in step S204, the Web display processing unit 251 terminates the scroll position determining processing.

In step S205 in the case where the display order is reversed, the Web display processing unit 251 excludes the Web part for which the display order is reversed, from the two Web parts (or candidates for the two Web parts). After the processing in step S205, the Web display processing unit 251 advances the process to step S206.

Further, in step S206, the Web display processing unit 251 determines whether there is a next closest Web part. The Web display processing unit 251 determines whether there is any Web part next closest to the scroll position in the display of the sending terminal device 10. If there is a next closest Web part (YES in step S206), the Web display processing unit 251 advances the process to step S207. If there is no next closest Web part (NO in step S206), the Web display processing unit 251 advances the process to step S208.

In step S207 in the case where there is a next closest Web part, the Web display processing unit 251 selects the next closest Web part as one of the above-described two Web parts. After the processing in step S207, the Web display processing unit 251 returns the process to step S202.

In step S208 in the case where there is no next closest Web part, the Web display processing unit 251 selects the top position Z or the bottom position H of the Web page in place of the Web part. After the processing in step S208, the Web display processing unit 251 advances the process to the step S204.

While the description was given of the case of using the ID name as an example of the part identification information for identifying the Web part in the above embodiment, text information included in the Web part or a file name included in the Web part, for example, may be used besides the ID name. Here, the text information included in the Web part may include, for example, a representative word or phrase included in the Web part.

As described above, the information sharing method according to the present embodiment is an information sharing method for sharing information between the terminal device 10 (first terminal device) and the terminal device 20 (second terminal device), and includes a first analysis step, a positional relationship generating step, a second analysis step, and a display step. In the first analysis step, the terminal device 10 (Web analysis unit 152) analyzes a structure of a Web page being displayed, and associates a Web part included in the Web page with an ID name (part identification information) included in the Web part and capable of identifying the Web part. In the positional relationship generating step, the terminal device 10 (positional relationship generating unit 153) generates a relative positional relationship between the Web part including the ID name and the central position CP1 (first display position) on the display screen of the terminal device 10 in a state where the Web page is being displayed thereon, on the basis of a first analysis result as an analysis result obtained in the first analysis step. In the second analysis step, the terminal device 20 (Web analysis unit 252) analyzes a structure of the Web page in a case of being displayed in the terminal device 20, and associates the Web part included in the Web page with the ID name. In the display step, the terminal device 20 (Web display processing unit 251) determines a second display position (for example, scroll position) for displaying the Web page on the display screen G2 of the terminal device 20, on the basis of the relative positional relationship generated in the positional relationship generating step and a second analysis result as an analysis result obtained in the second analysis step, and displays the Web page on the display screen G2 of the terminal device 20 at the second display position.

With this configuration, the information sharing method according to the present embodiment is able to display a Web page on the terminal device 10 (first terminal device) and the terminal device 20 (second terminal device) at the same display position (for example, scroll position), thereby enabling appropriate sharing of information between different terminal devices (10, 20). With the information sharing method according to the present embodiment, the scroll position (display position) can be shared even in the case, for example, where the terminal device 10 and the terminal device 20 have their display screens different in shape and size and the Web page is displayed thereon in different designs.

Further, in the present embodiment, in the display step, the terminal device 20 selects at least two Web parts closest in distance to the central position CP1 (first display position) in the display of the terminal device 10 on the basis of the relative positional relationships and the second analysis result. The terminal device 20 then determines a second display position as a scroll position of the Web page, on the basis of the relative positional relationships between the at least two Web parts selected and the central position CP1, and displays the Web page on the display screen G2 of the terminal device 20 by shifting the Web page to the scroll position.

With this configuration, the information sharing method according to the present embodiment allows the scroll position to be shared more appropriately, on the basis of the relative positional relationships between the two Web parts and the central position CP1, even in the case where the Web page display design differs between the terminal device 10 and the terminal device 20.

Further, in the present embodiment, the relative positional relationships between the two Web parts and the first display position correspond to a ratio between the distances of start positions of the Web parts from the central position CP1 (first display position).

With this configuration, the information sharing method according to the present embodiment is able to determine an appropriate scroll position in a simple manner.

Further, in the present embodiment, in the display step, in a case where one or both of the selected at least two Web parts do not exist in the display of the terminal device 20, the terminal device 20 selects the Web part(s) next closest in distance to the central position CP1 (first display position).

With this configuration, the information sharing method according to the present embodiment allows the scroll position to be shared appropriately even in the case where the terminal device 10 and the terminal device 20 have different Web parts of the Web page displayed thereon.

Further, in the present embodiment, in the display step, the terminal device 20 excludes any Web part that is displayed in the display of the terminal device 20 in reverse order as compared to that in the display of the terminal device 10, from (candidates for) the at least two Web parts selected.

With this configuration, the information sharing method according to the present embodiment is able to reduce an event that the shared scroll position takes an inappropriate position, for example the positions are misaligned, due to the Web parts displayed in reverse order.

Further, in the present embodiment, the part identification information that can identify a Web part includes an ID name of the Web part, text information included in the Web part, or a file name included in the Web part.

With this configuration, the information sharing method according to the present embodiment allows the scroll position to be shared more appropriately even in the case where the Web page display design differs between the terminal device 10 and the terminal device 20.

Further, the information sharing system 1 according to the present embodiment includes a terminal device 10 and a terminal device 20, and shares information between the terminal device 10 and the terminal device 20. The terminal device 10 includes a Web analysis unit 152 (first analysis unit) and a positional relationship generating unit 153. The Web analysis unit 152 analyzes a structure of a Web page being displayed by the terminal device 10, and associates a Web part included in the Web page with an ID name (part identification information) included in the Web part and capable of identifying the Web part. The positional relationship generating unit 153 generates, on the basis of a first analysis result as an analysis result obtained by the Web analysis unit 152, a relative positional relationship between the Web part including the ID name and a central position CP1 (first display position) on the display screen of the terminal device 10 in a state where the Web page is being displayed thereon. The terminal device 20 includes a Web analysis unit 252 (second analysis unit) and a Web display processing unit 251 (display processing unit). The Web analysis unit 252 analyzes a structure of the Web page in a case of being displayed in the terminal device 20, and associates the Web part included in the Web page with the ID name. The Web display processing unit 251 determines a second display position (for example, scroll position) for displaying the Web page on the display screen G2 of the terminal device 20, on the basis of the relative positional relationship generated by the positional relationship generating unit 153 and a second analysis result as an analysis result obtained by the Web analysis unit 252, and displays the Web page on the display screen G2 of the terminal device 20 at the second display position.

With this configuration, the information sharing system 1 according to the present embodiment exerts similar effects as the information sharing method according to the present embodiment described above, and enables appropriate sharing of information between different terminal devices (10, 20).

### Second Embodiment

An information sharing method and an information sharing system la according to a second embodiment will be described below with reference to the drawings.

In the present embodiment, a description will be given of an example where, besides the scroll position, cookie information accumulated when browsing a Web page and environmental information such as user agent information are shared between different terminal devices (10a, 20a).

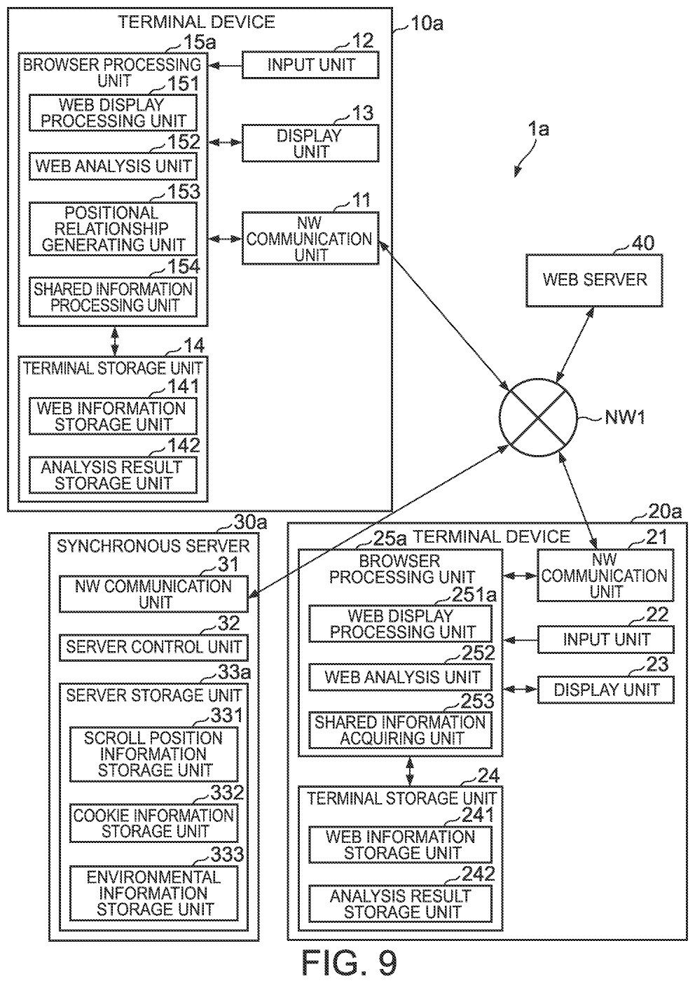

FIG. 9 is a block diagram showing an example of the information sharing system la according to the present embodiment.

As shown in FIG. 9, the information sharing system la includes a terminal device 10a, a terminal device 20a, a synchronous server 30a, and a Web server 40. The information sharing system la shares information (for example, display position of Web display) between the terminal device 10a and the terminal device 20a.

In FIG. 9, the same configurations as those in FIG. 1 are denoted by the same symbols, and the description thereof will be omitted.

Further, in the present embodiment, a description will be given of an example where the terminal device 10a corresponds to the first terminal device and the terminal device 20a corresponds to the second terminal device.

The terminal device 10a includes a network (NW) communication unit 11, an input unit 12, a display unit 13, a terminal storage unit 14, and a browser processing unit 15a.

The browser processing unit 15a is a functional unit that is implemented as a browser program is executed by a CPU and a memory (both not shown). The browser processing unit 15a acquires data on a Web page from the Web server 40, and displays the Web page on the display unit 13. The browser processing unit 15a includes a Web display processing unit 151, a Web analysis unit 152, a positional relationship generating unit 153, and a shared information processing unit 154.

The shared information processing unit 154 (an example of setup information output unit and environmental information output unit) outputs cookie information accumulated when browsing a Web page, to the outside (synchronous server 30a). Here, the cookie information includes information necessary for displaying a Web page, such as login information for the Web page displayed. The shared information processing unit 154 transmits the cookie information to the synchronous server 30a via the NW communication unit 11.

The shared information processing unit 154 further outputs user agent information, which is environmental information of the terminal device 10a when browsing a Web page, to the outside (synchronous server 30a). Here, the user agent information includes a program name of the browser, and shape and size information of the display screen. The shared information processing unit 154 transmits the user agent information (environmental information) to the synchronous server 30a via the NW communication unit 11.

The synchronous server 30a is a server device for sharing information (for example, scroll position, cookie information, and user agent information) between the sending terminal device 10a and the receiving terminal device 20a. The synchronous server 30a includes a NW communication unit 31, a server control unit 32, and a server storage unit 33a.

The server storage unit 33a stores various kinds of information used by the synchronous server 30a. The server storage unit 33a includes, for example, a scroll position information storage unit 331, a cookie information storage unit 332, and an environmental information storage unit 333.

The cookie information storage unit 332 stores the above-described cookie information. For example, the cookie information storage unit 332 stores a user ID (user identification information) of the synchronous server 30a, Web information (URL information etc.), and the cookie information in association with each other.

The environmental information storage unit 333 stores the above-described user agent information as the environmental information. For example, the environmental information storage unit 333 stores the user ID (user identification information) of the synchronous server 30a and the user agent information in association with each other.

The terminal device 20a is an information terminal such as a PC, for example, and displays a Web page acquired from the Web server 40 using a browser function of browsing Web pages. The terminal device 20a includes a NW communication unit 21, an input unit 22, a display unit 23, a terminal storage unit 24, and a browser processing unit 25a.

The browser processing unit 25a is a functional unit that is implemented as a browser program is executed by a CPU and a memory (both not shown). The browser processing unit 25a acquires data on a Web page from the Web server 40, and displays the Web page on the display unit 23. The browser processing unit 25a includes a Web display processing unit 251a, a Web analysis unit 252, and a shared information acquiring unit 253.

The shared information acquiring unit 253 (an example of setup information acquiring unit and environmental information acquiring unit) acquires cookie information output from the terminal device 10a, via the synchronous server 30a. That is to say, the shared information acquiring unit 253 acquires the cookie information stored in the cookie information storage unit 332 in the synchronous server 30a, via the NW communication unit 21.

The shared information acquiring unit 253 further acquires user agent information output from the terminal device 10a, via the synchronous server 30a. That is to say, the shared information acquiring unit 253 acquires the user agent information stored in the environmental information storage unit 333 in the synchronous server 30a, via the NW communication unit 21.

The Web display processing unit 251a performs processing basically similar to that of the Web display processing unit 251 in the first embodiment described above. The Web display processing unit 251a performs added processing of sharing cookie information and user agent information. A description will now be given of the added processing.

The Web display processing unit 251a displays a Web page by sharing the cookie information, acquired by the shared information acquiring unit 253, with the terminal device 10a. That is to say, the Web display processing unit 251a uses the same login information as that for the Web page being displayed, for example, to display the same Web page.

Further, the Web display processing unit 251a transmits the user agent information, acquired by the shared information acquiring unit 253, to the Web server 40 to acquire the Web page. That is to say, the Web display processing unit 251a acquires a Web page in the same environment as the sending terminal device 10a, and displays the acquired Web page.

The operation of the information sharing system la according to the present embodiment will be described below with reference to the drawings.

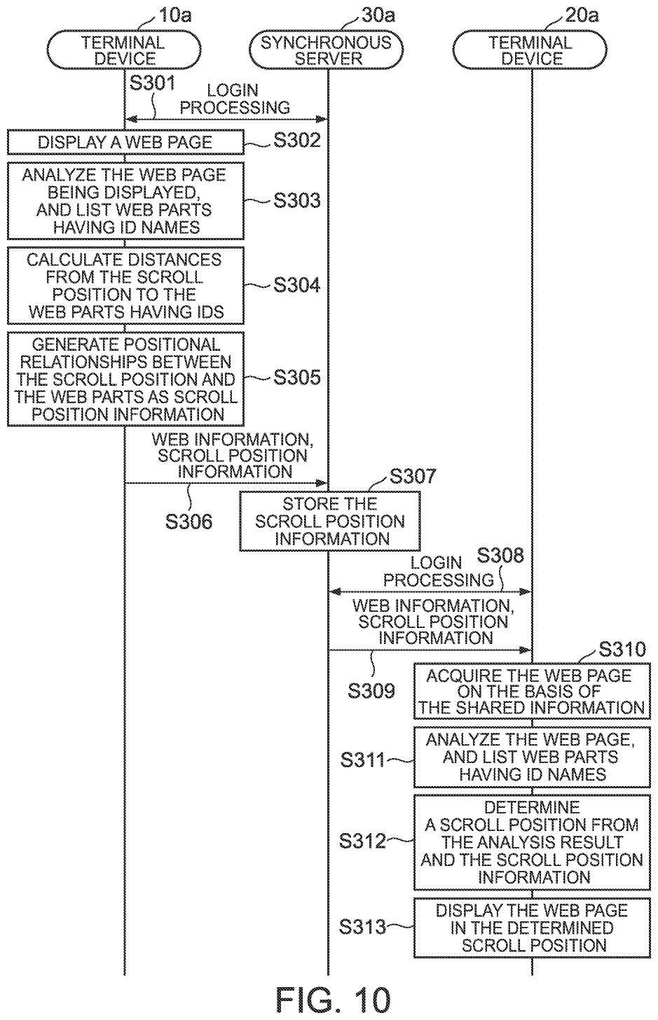

FIG. 10 shows, by way of example, the operation of the information sharing system la according to the present embodiment.

Here, a description will be given of an example where the Web page being displayed by the sending terminal device 10a is to be displayed on the receiving terminal device 20a with the scroll position, cookie information, and user agent information shared (synchronized) therebetween.

In FIG. 10, steps S301 to S305 are identical in processing to the steps S101 to S105 shown in FIG. 7, so the description thereof will be omitted.

In step S306, the terminal device 10a transmits the Web information, the scroll position information, and the shared information, to the synchronous server 30a. The positional relationship generating unit 153 transmits the generated scroll position information and the Web information (for example, URL information of the Web page) to the synchronous server 30a via the NW communication unit 11. The shared information processing unit 154 transmits the shared information to the synchronous server 30a via the NW communication unit 11. Here, the shared information includes the above-described cookie information and user agent information.

Next, the synchronous server 30a stores the scroll position information and the shared information (step S307). The server control unit 32 of the synchronous server 30a receives, via the NW communication unit 31, the scroll position information, the Web information (for example, URL information of the Web page), and the shared information (cookie information and user agent information). For example, the server control unit 32 stores the received scroll position information, the Web information (for example, URL information of the Web page), and the user ID, in association with each other, in the scroll position information storage unit 331 of the server storage unit 33a.

Further, for example, the server control unit 32 stores the received cookie information, the Web information (for example, URL information of the Web page), and the user ID, in association with each other, in the cookie information storage unit 332 of the server storage unit 33a. Furthermore, for example, the server control unit 32 stores the received user agent information and the user ID, in association with each other, in the environmental information storage unit 333 of the server storage unit 33a.

Next, when a browser program is started by a user, the terminal device 20a performs login processing on the synchronous server 30a (step S308).

Here, it is assumed that the user of the terminal device 10a and the user of the terminal device 20a are the same, or, the same user ID is used for logging in to the synchronous server 30a.

Next, the synchronous server 30a transmits the Web information, the scroll position information, and the shared information to the terminal device 20a (step S309). The server control unit 32 acquires the Web information (URL information) and the scroll position information corresponding to the logged-in user ID from the scroll position information storage unit 331, and transmits the acquired Web information (URL information) and scroll position information to the terminal device 20a via the NW communication unit 31.

Further, the server control unit 32 acquires cookie information corresponding to the logged-in user ID and the Web information (URL information) from the cookie information storage unit 332. Further, the server control unit 32 acquires user agent information corresponding to the logged-in user ID from the environmental information storage unit 333. The server control unit 32 transmits the acquired cookie information and user agent information, as the shared information, to the terminal device 20a via the NW communication unit 31.

Next, the terminal device 20a acquires a Web page on the basis of the shared information (step S310). The shared information acquiring unit 253 of the browser processing unit 25a acquires the shared information from the synchronous server 30a via the NW communication unit 21. The Web display processing unit 251a also acquires data on the Web page corresponding to the Web information (URL information) acquired from the synchronous server 30a via the NW communication unit 21, by using the acquired shared information. The Web display processing unit 251a stores the acquired Web page data in the Web information storage unit 241 of the terminal storage unit 24.

The following steps S311 to S313 are identical in processing to the above-described steps S111 to S113 in FIG. 7, so the description thereof will be omitted.

As described above, the information sharing method (information sharing system 1a) according to the present embodiment includes a setup information outputting step and a setup information acquiring step. In the setup information outputting step, the terminal device 10a (shared information processing unit 154) outputs cookie information accumulated when browsing the Web page to the outside (synchronous server 30a). In the setup information acquiring step, the terminal device 20a (shared information acquiring unit 253) acquires the cookie information output in the setup information outputting step. In the display step, the terminal device 20a (Web display processing unit 251a) displays the Web page by sharing the cookie information acquired in the setup information acquiring step with the terminal device 10a.

With this configuration, the information sharing method and the information sharing system la according to the present embodiment enable sharing (synchronization) of the display between different terminal devices (10a, 20a) by sharing the cookie information, even in the case, for example, where the Web page requires login or the like.

Further, the information sharing method (information sharing system la) according to the present embodiment includes an environmental information outputting step and an environmental information acquiring step. In the environmental information outputting step, the terminal device 10a (shared information processing unit 154) outputs user agent information, as environmental information of the terminal device 10a when browsing the Web page, to the outside (synchronous server 30a). In the environmental information acquiring step, the terminal device 20a (shared information acquiring unit 253) acquires the user agent information output in the environmental information outputting step. In the display step, the terminal device 20a (Web display processing unit 251a) acquires the Web page by transmitting the user agent information acquired in the environmental information acquiring step to the Web server 40.

With this configuration, the information sharing method and the information sharing system la according to the present embodiment enable sharing (synchronization) of the display of the Web page between different terminal devices (10a, 20a) in the exactly comparable environments, for example, by sharing the user agent information.

### Third Embodiment

An information sharing method and an information sharing system lb according to a third embodiment will be described below with reference to the drawings.

In the present embodiment, a description will be given of a modification of the above-described first embodiment in which the scroll position is shared mutually between different terminal devices (10b, 20b).

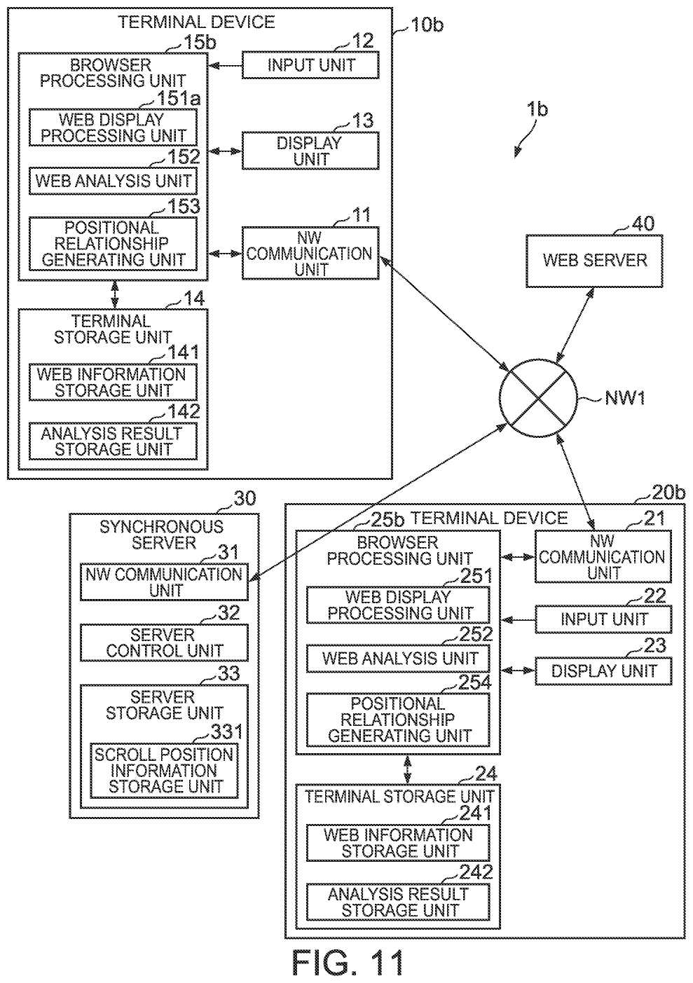

FIG. 11 is a block diagram showing an example of the information sharing system lb according to the third embodiment.

As shown in FIG. 11, the information sharing system 1b includes a terminal device 10b, a terminal device 20b, a synchronous server 30, and a Web server 40. The information sharing system 1b shares information (for example, display position of Web display) between the terminal device 10b and the terminal device 20b.

In FIG. 11, the same configurations as those in FIG. 1 are denoted by the same symbols, and the description thereof will be omitted.

In the present embodiment, the terminal device 10b and the terminal device 20b each function as a sending terminal device (first terminal device) as well as a receiving terminal device (second terminal device).

The terminal device 10b includes a network (NW) communication unit 11, an input unit 12, a display unit 13, a terminal storage unit 14, and a browser processing unit 15b.

The browser processing unit 15b is a functional unit that is implemented as a browser program is executed by a CPU and a memory (both not shown). The browser processing unit 15b acquires data on a Web page from the Web server 40, and displays the Web page on the display unit 13. The browser processing unit 15b includes a Web display processing unit 151a, a Web analysis unit 152, and a positional relationship generating unit 153.

The Web display processing unit 151a functions as the Web display processing unit 151 in the first embodiment described above, and also as the Web display processing unit 251 in the first embodiment.

The terminal device 20b includes a NW communication unit 21, an input unit 22, a display unit 23, a terminal storage unit 24, and a browser processing unit 25b.

The browser processing unit 25b is a functional unit that is implemented as a browser program is executed by a CPU and a memory (both not shown). The browser processing unit 25b acquires data on a Web page from the Web server 40, and displays the Web page on the display unit 23. The browser processing unit 25b includes a Web display processing unit 251, a Web analysis unit 252, and a positional relationship generating unit 254.

The positional relationship generating unit 254 functions similarly as the above-described positional relationship generating unit 153 in the first embodiment.

As described above, in the information sharing method (and information sharing system lb) according to the present embodiment, both of the terminal device 10b and the terminal device 20b have the functions similar to those of the positional relationship generating unit 153 and the Web display processing unit 251 in the first embodiment. Therefore, in the information sharing method (and information sharing system lb) according to the present embodiment, different terminal devices (10b, 20b) are allowed to mutually share the display position (scroll position).

It should be noted that the present invention is not limited to the above embodiments; rather, modifications are possible within a range not departing from the gist of the present invention.

For example, while the description was given, in each of the above embodiments, of the example where the information sharing system 1 (1a, 1b) shares information between two terminal devices, not limited thereto, information may be shared among three or more terminal devices. That is to say, information sharing may be on a one-to-many basis among terminal devices, besides the one-to-one basis between two devices.

Further, while the description was given, in each of the above embodiments, of the example where information is shared between terminal devices of the same user, information may be shared between terminal devices of different users.

Furthermore, while the description was given, in each of the above embodiments, of the example where the information sharing function is implemented as a browser program is executed by a CPU and a memory, the information sharing function may be implemented by using a plug-in function of the browser program.

Further, while the description was given, in each of the above embodiments, of the example where the central positions of the display screens are synchronized as the shared scroll position, not limited thereto, the top of the display screens or the end of the display screens may be synchronized.

Further, while the description was given, in the second embodiment, of the example where cookie information and environmental information are both shared, either one of them alone may be shared. Furthermore, the terminal device 20a may be configured, when it cannot display the Web information satisfactorily, to display the same by sharing the environmental information (user agent information).

Further, while the description was given of the example where the third embodiment is applied to the first embodiment, it may be applied to the second embodiment in a similar manner.

It should be noted that the components included in the above-described information sharing system 1 (1a, 1b) each have a computer system therein. A program for implementing the function of each component included in the information sharing system 1 (1a, 1b) may be recorded on a computer readable recording medium, and the program recorded on the recording medium may be read and executed by the computer system, so that the above-described processing in each component included in the information sharing system 1 (1a, 1b) is carried out. Here, that “the program recorded on the recording medium (is) read and executed by the computer system” means that the program is installed into the computer system. As used herein, the “computer system” includes an OS and hardware such as peripherals.

Further, the “computer system” may include a plurality of computer devices connected via the Internet, WAN, LAN, and/or a network including a dedicated line or other communication line. The “computer readable recording medium” refers to a portable medium such as a flexible disk, a magneto-optical disk, a ROM, a CD-ROM, etc., and a storage device such as a hard disk built in the computer system. As such, the recording medium having the program stored therein may be a non-transitory recording medium such as a CD-ROM or the like.

The recording medium also includes an internally or externally provided recording medium which is accessible from a distribution server for distributing the program. The program may be divided into a plurality of parts, which may be downloaded at different timings and then combined together in each component included in the information sharing system (1a, 1b). The divided parts of the program may be distributed by different distribution servers. Further, the “computer readable recording medium” includes one that retains the program for a certain period of time, such as a volatile memory (RAM) inside the computer system serving as a client or a server in the case where the program is transmitted via the network. Further, the program may be one for implementing some of the above-described functions. Furthermore, the program may be what is called a differential file (differential program) that can implement the above-described functions in combination with the program(s) already recorded in the computer system.

Further, some or all of the above-described functions may be implemented as an integrated circuit such as large scale integration (LSI) or the like. The above functions may be implemented as individual processors, or some or all of the functions may be integrated into a processor. The circuit integration technique is not limited to the LSI; circuit integration may be implemented by a dedicated circuit or a general-purpose processor. Furthermore, in a case where a novel circuit integration technique replacing the LSI appears with the advance of the semiconductor technology, an integrated circuit implemented by that technique may be used.

1. An information sharing method for sharing information between a first terminal device and a second terminal device, the method comprising:
a first analysis step, performed by the first terminal device, of analyzing a structure of a Web page being displayed, and associating a Web part included in the Web page with part identification information included in the Web part and which identifies the Web part;
a positional relationship generating step, performed by the first terminal device on the basis of a first analysis result obtained in the first analysis step, of generating a relative positional relationship between the Web part including the part identification information and a first display position on a display screen of the first terminal device when the Web page is displayed thereon;
a second analysis step, performed by the second terminal device, of analyzing a structure of the Web page being displayed in the second terminal device, and associating the Web part included in the Web page with the part identification information; and
a display step, performed by the second terminal device, of determining a second display position for displaying the Web page on a display screen of the second terminal device on the basis of the relative positional relationship generated in the positional relationship generating step and a second analysis result obtained in the second analysis step, and displaying the Web page on the display screen of the second terminal device at the second display position.

2. The information sharing method according to claim 1, wherein in the display step, the second terminal device selects at least two said Web parts closest in distance to the first display position in the display of the first terminal device on the basis of the relative positional relationships and the second analysis result, determines the second display position as a scroll position of the Web page on the basis of the relative positional relationships between the selected at least two Web parts and the first display position, and displays the Web page on the display screen of the second terminal device by shifting the Web page to the scroll position.

3. The information sharing method according to claim 2, wherein the relative positional relationships between the selected at least two Web parts and the first display position correspond to a ratio between distances of start positions of the selected at least two Web parts from the first display position.

4. The information sharing method according to claim 2, wherein in the display step, when one or both of the selected at least two Web parts do not exist in the display of the second terminal device, the second terminal device selects one or two said Web parts next closest in distance to the first display position.

5. The information sharing method according to claim 2, wherein in the display step, the second terminal device excludes any said Web part that is displayed in the display of the second terminal device in reverse order as compared to that in the display of the first terminal device, from candidates for the at least two selected Web parts.

6. The information sharing method according to claim 1, wherein the part identification information includes an ID name of the Web part, text information included in the Web part, or a file name included in the Web part.

7. The information sharing method according to claim 1, further comprising:
a setup information outputting step, performed by the first terminal device, of outputting cookie information accumulated when browsing the Web page to an apparatus outside of the first and second terminal devices; and
a setup information acquiring step, performed by the second terminal device, of acquiring the cookie information output in the setup information outputting step, wherein:
in the display step, the second terminal device displays the Web page by sharing the cookie information acquired in the setup information acquiring step with the first terminal device.

8. The information sharing method according to claim 1, further comprising:
an environmental information outputting step, performed by the first terminal device, of outputting user agent information as environmental information of the first terminal device when browsing the Web page to an apparatus outside of the first and second terminal devices; and
an environmental information acquiring step, performed by the second terminal device, of acquiring the user agent information output in the environmental information outputting step, wherein:
in the display step, the second terminal device acquires the Web page by transmitting the user agent information acquired in the environmental information acquiring step to a Web server.

9. An information sharing system including a first terminal device and a second terminal device and sharing information between the first terminal device and the second terminal device,
the first terminal device comprising:
a first analysis unit configured to analyze a structure of a Web page being displayed by the first terminal device, and associate a Web part included in the Web page with part identification information included in the Web part and which identifies the Web part; and
a positional relationship generating unit configured to generate, on the basis of a first analysis result obtained by the first analysis unit, a relative positional relationship between the Web part including the part identification information and a first display position on a display screen of the first terminal device when the Web page is displayed thereon,
the second terminal device comprising:
a second analysis unit configured to analyze a structure of the Web page being displayed in the second terminal device, and associate the Web part included in the Web page with the part identification information; and
a display processing unit configured to determine a second display position for displaying the Web page on a display screen of the second terminal device, on the basis of the relative positional relationship generated by the positional relationship generating unit and a second analysis result obtained by the second analysis unit, and display the Web page on the display screen of the second terminal device at the second display position.
